(19) United States
(12) Patent Application Publication
(10) Pub. No.: US 2026/0047971 A1
(43) Pub. Date: Feb. 19, 2026

(54) COMPRESSION SHAPEWEAR GARMENT

(71) Applicant: L&R USA INC., Milwaukee, WI (US)

(72) Inventors: Jianne Wade, Milwaukee, WI (US); David Lischka, Milwaukee, WI (US); Adam Van Essen, Milwaukee, WI (US)

(21) Appl. No.: 19/299,092

(22) Filed: Aug. 13, 2025

Related U.S. Application Data
(60) Provisional application No. 63/682,693, filed on Aug. 13, 2024.

(51) Int. Cl. A61H 1/00; A41D 13/12

(52) U.S. Cl. CPC A61H 1/008; A41D 13/1236; A61H 2201/165

(57) ABSTRACT

A garment to be worn by a patient, the garment including a first layer of sheet material forming a tissue contacting surface, where the tissue contacting surface at least partially defines a treatment volume sized to receive at least a portion of the patient's body therein, and where the first layer of sheet material includes one or more protuberances configured to engage the at least a portion of the patient's body when the at least a portion of the patient's body is positioned within the treatment volume. The garment also including a second layer of sheet material coupled to the first layer of sheet material, where the second layer of sheet material is configured to compress the first layer of sheet material into engagement with the at least a portion of the patient's body when the at least a portion of the patient's body is positioned within the treatment volume.

### RELATED APPLICATIONS

This application claims priority to U.S. Provisional Application No. 63/682,693, filed on Aug. 13, 2024. The entire contents of which is hereby incorporated by reference.

### FIELD

The present disclosure relates to shapewear garments that provide compression, and more specifically to customized shapewear garments that promote compression, massage, and lymph fluid movement.

### BACKGROUND

Existing compression shapewear garments typically utilize knitting techniques or filler materials such as shaped polyurethane foam to create protuberances on the garment's surface.

### SUMMARY

In one aspect, a garment to be worn by a patient, the garment including a first layer of sheet material forming a tissue contacting surface, where the tissue contacting surface at least partially defines a treatment volume sized and shaped to receive at least a portion of the patient's body therein, and where the first layer of sheet material includes one or more protuberances formed into the tissue contacting surface configured to engage the at least a portion of the patient's body when the at least a portion of the patient's body is positioned within the treatment volume, and a second layer of sheet material coupled to the first layer of sheet material, where the second layer of sheet material is configured to compress the first layer of sheet material into engagement with the at least a portion of the patient's body when the at least a portion of the patient's body is positioned within the treatment volume.

Alternatively or additionally, in any combination, where the first layer of sheet material is a first fabric formed from a plurality of threads, and where the plurality of threads form the one or more protuberances.

Alternatively or additionally, in any combination, where the first layer of sheet material includes an intermediate surface opposite the tissue contacting surface, and where the protuberances are formed into the tissue contacting surface and not the intermediate surface.

Alternatively or additionally, in any combination, where the first layer of sheet material defines a first thickness, and where the first thickness varies to produce the one or more protuberances.

Alternatively or additionally, in any combination, where the first layer of sheet material is movable relative to the second layer of sheet material.

Alternatively or additionally, in any combination, where the first layer of sheet material is formed from one or more panels coupled together.

Alternatively or additionally, in any combination, where each panel includes a perimeter, and where the first layer is attached to the second layer along the perimeter of at least some of the panels.

Alternatively or additionally, in any combination, where each panel includes a perimeter, and where the first layer of sheet material is attached to the second layer of sheet material only at the perimeter of at least some of the panels.

Alternatively or additionally, in any combination, where the one or more protuberances include one or more elongated ridges.

Alternatively or additionally, in any combination, where the first layer of compressive material and the second layer of compressive material form a body, and where the body has a first end and a second end opposite the first end, and where the treatment volume is open on both the first end and the second end of the body.

Alternatively or additionally, in any combination, where the body is configured to apply a first compressive force at the first end, and a second compressive force less than the first compressive force at the second end.

Alternatively or additionally, in any combination, where the treatment volume defines a treatment volume axis, and wherein the protuberances include ridges extending substantially parallel to the treatment volume axis.

Alternatively or additionally, in any combination, where the second layer of sheet material encompasses the first layer and forms an exterior surface of the body.

Alternatively or additionally, in any combination, further including a third layer of material positioned between the first layer of sheet material and the second layer of sheet material.

Alternatively or additionally, in any combination, where the first layer of sheet material is formed from a first fabric type, and where the second layer of sheet material is formed from a second fabric type different than the first fabric type.

In another aspect, a garment to be worn by a patient, the garment including a first layer of sheet material forming a tissue contacting surface, where the tissue contacting surface at least partially defines a treatment volume sized and shaped to receive at least a portion of the patient's body therein, where the first layer of sheet material is formed from one or more panels coupled together, and where each panel includes a perimeter, and a second layer of sheet material coupled to the first layer of sheet material along the perimeter of at least some of the panels, where the second layer of sheet material is configured to compress the first layer of sheet material into engagement with the at least a portion of the patient's body when the at least a portion of the patient's body is positioned within the treatment volume.

Alternatively or additionally, in any combination, where at least a portion of the first layer of sheet material can move relative to the second layer of sheet material.

Alternatively or additionally, in any combination, where the first layer includes one or more protuberances formed into the tissue contacting surface and configured to engage the patient's body.

Alternatively or additionally, in any combination, where the second layer of sheet material is coupled to the first layer of sheet material only along the perimeter of at least some of the panels.

Alternatively or additionally, in any combination, where the first layer of sheet material is a first fabric, and wherein the second layer of sheet material is a second fabric different than the first fabric.

### BRIEF DESCRIPTION OF THE DRAWINGS

FIG. 1 is an end view of a compression shapewear garment in a closed configuration according to an embodiment of the present disclosure.

FIG. 2A is an end view of a compression shapewear garment in a closed configuration according to another embodiment of the present disclosure.

FIG. 2B is a side view of the compression shapewear garment of FIG. 2A.

FIG. 3 is an end view of the compression shapewear garment of FIG. 2A in an open configuration.

FIG. 4 is a detailed view of a plurality of protuberances of the compression shapewear garment of FIG. 2A.

FIG. 5 is a detailed view of a body of the compression shapewear garment of FIG. 2A.

FIGS. 6-8 are detailed views of alternative embodiments of a body of the compression shapewear garment of FIG. 2A.

FIG. 9 is a top view of the body of the compression shapewear garment of FIG. 3.

FIGS. 10-17 are top views of alternative embodiments of a body of the compression shapewear garment of FIG. 3.

FIGS. 18-24 illustrate alternative embodiments of the compression shapewear garment of FIG. 2A configured to be applied to various locations on the body of a patient.

FIG. 25 is perspective view of a compression shapewear garment according to another embodiment of the present disclosure.

FIG. 25A is a section view taken along line 25A-25A of FIG. 25.

FIGS. 26 and 27 illustrate a compression shapewear garment according to another embodiment of the present disclosure.

FIG. 26A is a section view taken along line 26A-26A of FIG. 26.

### DETAILED DESCRIPTION

Before any embodiments are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings.

Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%) of an indicated value.

Existing compression garments typically utilize knitting techniques or filler materials such as shaped polyurethane foam to create protuberances on the surface of the garment. However, these methods have limitations. Knitted garments often have protuberances visible on both the inside and outside surfaces of the garment which can cause discomfort to the patient or have an undesired appearance. Furthermore, garments using filler materials are often bulky and stiff.

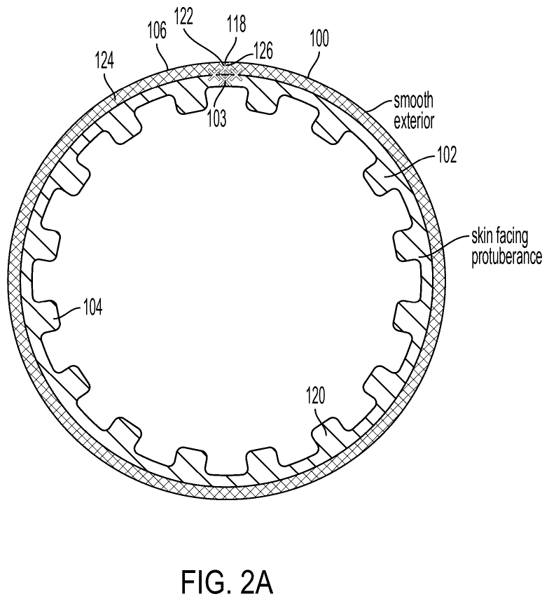

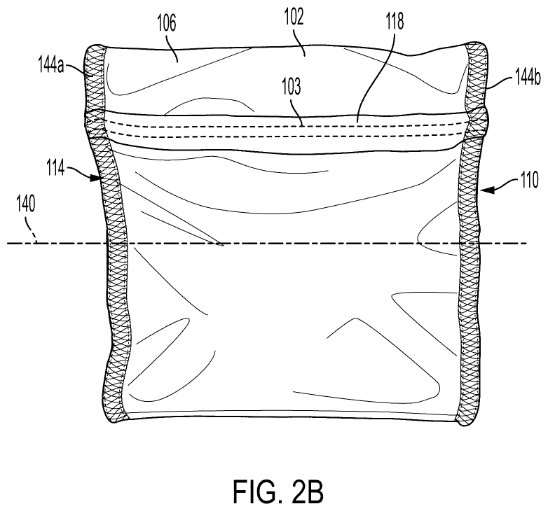

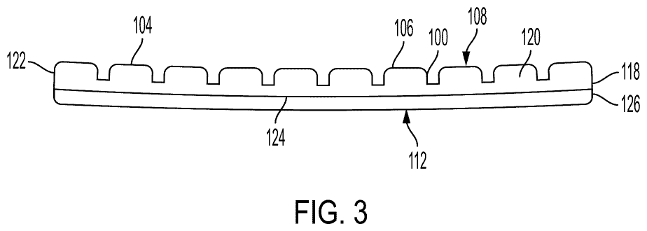

FIGS. 2A-3 illustrate a compression garment 100 to be worn by a patient to induce micro-massage effects and facilitate the movement of lymph fluid within the patient's tissue while being worn. The illustrated garment 100 is of particular benefit to patients with lymphedema, lipedema, venous conditions, and other edema-related conditions.

The garment 100 includes a body 106 defining a treatment passage or volume 136 in which a pre-determined area or at least a portion of a patient's body (e.g., an arm, a leg, torso, and the like) may be placed for treatment. The body 106, in turn, includes a tissue contacting surface 108 at least partially defining the treatment volume 136 and including one or more protuberances 104 formed therein. The body 106 also includes an outer facing or exterior surface 112 opposite the tissue contact surface 108. During use, the body 106 is configured to surround or otherwise encompass the at least a portion of the patient's body positioned within the volume 136 and apply a compressive force thereto. The compressive forces generated by the body 106 of the garment 100 then serve to bias the tissue contacting surface 108, and corresponding protuberances 104, into engagement with the patient's skin.

While being worn, the protuberances 104 are sized, shaped, and positioned on the tissue contacting surface 108 so that the user's own movements (e.g., moving an arm relative to his or her body or bending an elbow) produces a micro-massage effect in the area where the protuberances 104 are in contact with the user's body. In some embodiments, the protuberances 104 may also be sized, shaped, and positioned to direct the flow of lymph fluid within the body in addition to or in place of the micro-massage effect. In some embodiments, the protuberances 104 may be flexible such they can compress and deflect in response to the movement of the patient's body within the treatment volume 136 to help produce the desired micro-massage effect.

As shown in FIGS. 2A-2B, the body 106 of the garment 100 is substantially elongated in shape having a first end 144a, and a second end 144b opposite the first end 144a. The body 106 also defines a body axis 140 extending therethrough (e.g., passing through both the first and second ends 144a, 144b), and a body reference surface 116 that corresponds with the body's overall shape. In some embodiments, the working volume 136 defined by body 106 is also elongated in shape extending co-axial with the body axis 140 and being open on both ends of the body 144a, 144b (e.g., forming an open channel extending through the body 106).

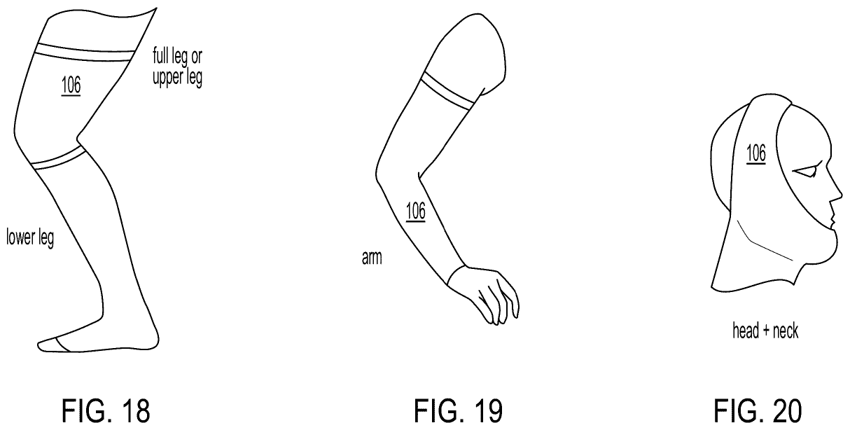

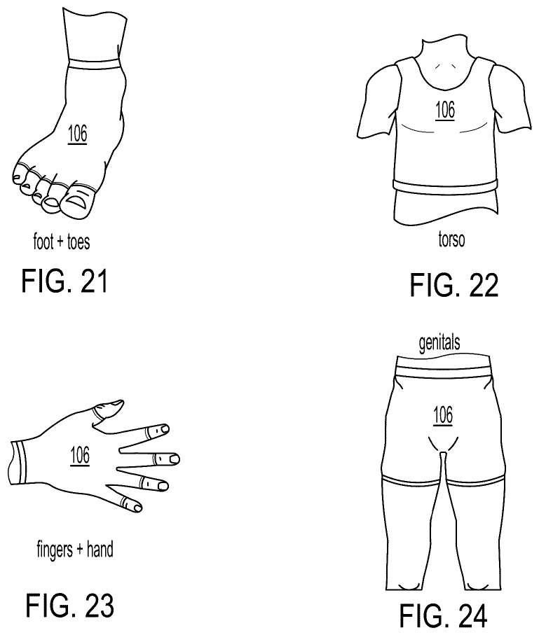

In the illustrated embodiment, the body 106 is tubular in shape and sized to receive all or part of an arm or leg within the treatment volume 136. The body reference surface 116 is also tubular being co-axial with the body axis 140. In other embodiments, the body 106 may take on other shapes to accommodate different regions of the patient's body. For example, the body 106 may have a more frusto-conical tapered shape to accommodate the upper regions of a patient's leg (see FIG. 18). In still other embodiments, the body 106 may be elongated with an angular bend therein to accommodate an elbow, knee, and/or foot (see FIGS. 19 and 25-17). In still other embodiments, the body 106 may be shaped like a gauntlet or glove so that the body 106 may encompass the patient's hands and/or fingers (see FIG. 23). In still other embodiments, the body 106 may be shaped like a sock or boot so that the body 106 may encompass the patient's feet and/or toes (see FIG. 21). In still other embodiments, the body 106 may be shaped like a balaclava so that the body 106 may encompass at least a portion of the patient's head and/or neck (see FIG. 20). In still other embodiments, the body 106 may be shaped like a long or short sleeved shirt so that the body 106 may encompass at least a portion of the patient's torso and/or arms (see FIG. 22). In still other embodiments, the body 106 may be shaped like a pant, short, or brief so that the body 106 may encompass at least a portion of the patient's hips, legs, and/or genital areas (see FIG. 24). In still other embodiments, the body 106 may include combinations of the above shapes to accommodate larger portions of the patient's body. In still other embodiments, a body 106 representing an entire bodysuit could be formed.

In some embodiments, the body 106 of the garment 100 is sized and shaped to produce a pressure gradient within the treatment volume 136. In such embodiments, the fit and/or material of the body 106 may be adjusted to vary the pressure applied to the patient's body at various points and/or regions along the garment 100. For example, a stiffer material or reinforcement pieces may be used to increase the compressive pressure applied to the patient, while weaker materials may be used to decrease the compressive pressure applied to the patient. Furthermore, a looser fit may be used to decrease the compressive pressure applied to the patient, while a tighter fit may be used to increase the compressive pressure applied to the patient when a single constant-compression material is used throughout.

In some embodiments, the compressive pressure applied by the garment 100 is adjusted along the axial length thereof to produce one or more high pressure regions 110, where a first compressive pressure is applied to the patient's body, and one or more low pressure regions 114, where a second compressive pressure lower than the first compressive pressure is applied to the patient's body. In the illustrated embodiment, the high-pressure region 110 is positioned proximate the first end 144a of the body 102 while the low-pressure region 114 is positioned proximate the second or opposite end 144b of the body 106. In some embodiments, the shape and fit of the garment 100 is configured so that the body 106 produces a smooth pressure gradient along the length of the body 106 between the high-pressure region 110 and the low-pressure region 114.

When being worn, the above-described pressure gradient is configured so that the high-pressure regions 110 are positioned relatively farther from the patient's torso or core while the low-pressure regions 114 are positioned relatively closer to the patient's torso or core. By doing so, the pressure gradient generated by the garment 100 forces lymph and other fluids to flow toward the torso or core area (e.g., in the direction of the pressure gradient). In other embodiments, the pressure gradient generated by the garment 100 may be used to direct lymph and other fluids to or away from a particular lymph node or other region of the body (e.g., away from damaged or underperforming lymph nodes, away from an area of swelling, toward alternate lymphatic pathways and the like). In other embodiments, other high-pressure and low-pressure regions 110, 114 may be positioned along the length of the garment 100.

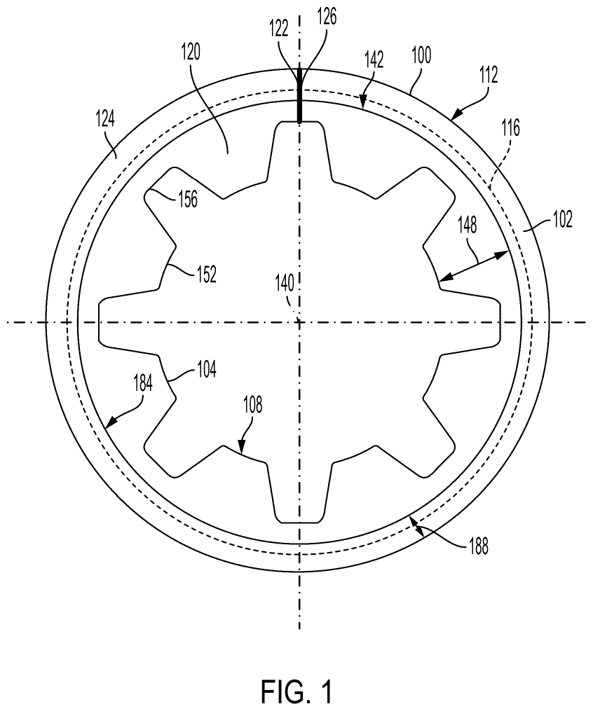

As shown in FIGS. 1-3, the body 106 of the garment 100 is formed from one or more panels 102 coupled together to form the desired body shape. Each panel 102, in turn, is cut from or otherwise formed from one or more layers of flexible sheet material (i.e., fabric) that together form the tissue contact surface 108 and the outer facing or exterior surface 112. In some embodiments, the individual layers of sheet material (e.g., fabric) are coupled together (e.g., sewn together) to form an individual panel 102. In embodiments where multiple panels 102 are present, the multiple panels (e.g., each consisting of the multiple layers of sheet material sewn together) may then be attached to each to form the desired body shape (e.g., enclosing the treatment volume 136 therein). In some embodiments, the panels 102 are shaped so that the connections between the panels 102 occur along the perimeters thereof (e.g., the panels 102 are sewn together along their perimeters). In embodiments where only a single panel 102 is present, the perimeter of the single panel may be attached to itself in one or more locations to form the desired body shape. In the illustrated embodiment, the body 106 is formed from a single rectangular panel 102 (see FIG. 2B). However, in other embodiments more and/or different shaped panels 102 may be present (described below).

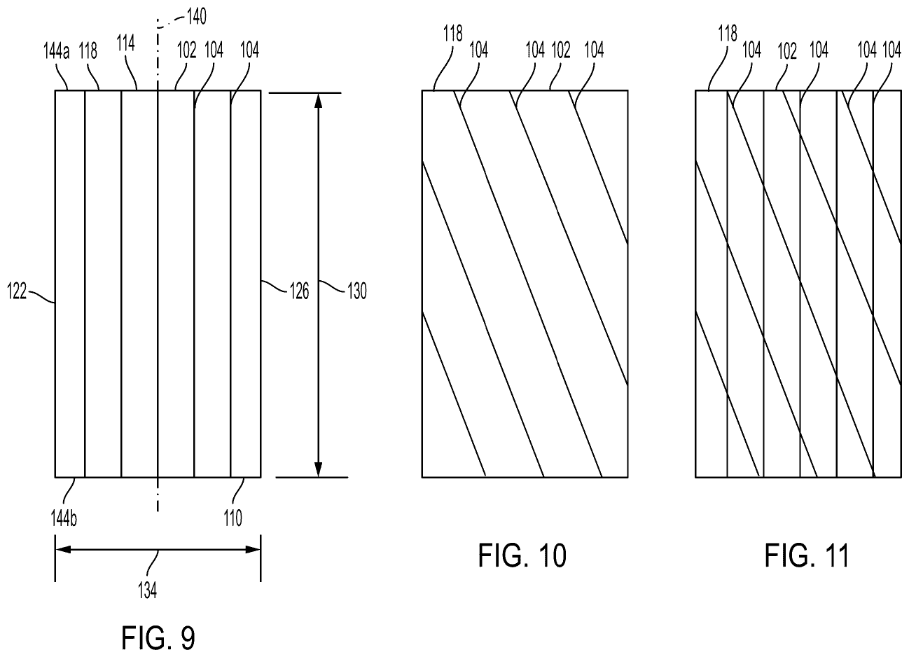

As shown in FIG. 9, the panel 102 forming the body 106 includes a perimeter 118 establishing a panel length 130 and a panel width 134 (e.g., generally corresponding to the axial length and circumferential length of the body 106, respectively). The perimeter 118 also includes a first seam edge 122, a second seam edge 126 opposite the first seam edge 122, the first end 144a of the body 106, and the second end 144b of the body 106. In some embodiments, the seam edges 122, 126 may be permanently coupled to each other (i.e., via adhesive, stitching 103, and the like; see FIG. 2B) to form the working or closed garment shape. However, in other embodiments, the first seam edge 122 may be detachably coupled to the second seam edge 126 (i.e., via buttons, a zipper, clips, and the like) so that the panel 102 may be manipulated between an open configuration (see FIG. 3), in which the two seam edges 122, 126 are detached from each other and the tissue contacting surface 108 is open and does not form an enclosed shape, and a closed configuration (see FIG. 2A), in which the two seam edges 122, 126 are coupled to each other and the tissue contacting surface 108 forms an enclosed shape. In some embodiments, the tissue contacting surface 108 forms an enclosed shape if a reference plane passing through the tissue contacting surface 108 (e.g., oriented normal to the body axis 140) reveals a cross-sectional shape that is completely enclosed (i.e., a circle, square, polygon, and the like).

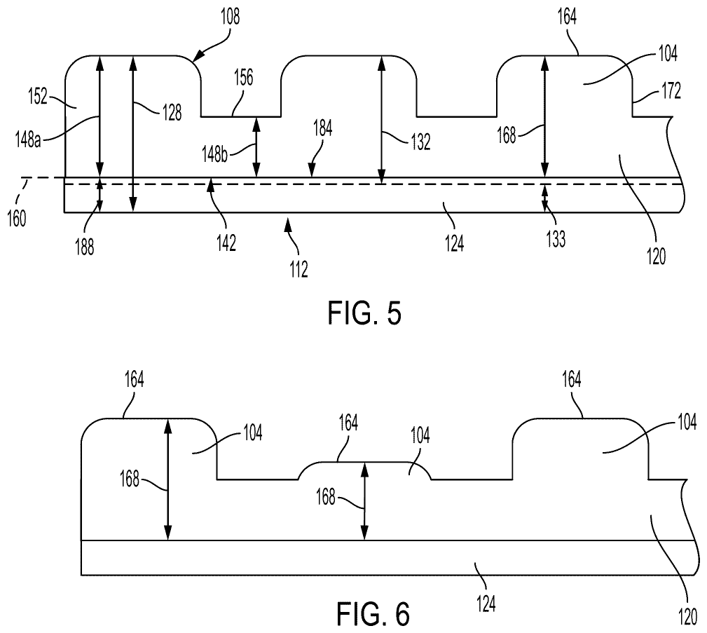

The panel 102 also defines a panel thickness 128 measured between the tissue contact surface 108 and the exterior surface 112, an interior offset 132 measured between the tissue contact surface 108 and the body reference surface 116, and an exterior offset 133 measured between the exterior surface 112 and the body reference surface 116 (see FIG. 5). In the illustrated embodiment, the panel thickness 128 varies at different locations of the panel 102 with the panel thickness 128 being relatively larger where a protuberance 104 is present. Similarly, the illustrated interior offset 132 also varies at different locations on the panel 102 with the interior offset 132 being relatively larger where a protuberance 104 is present. In contrast, in some embodiments the magnitude of the exterior offset 133 is independent of the presence or absence of protuberances 104. Indeed, in the illustrated embodiment the exterior offset 133 is substantially constant (±0.1%, ±0.5%, ±1%, ±2%, ±5%, or ±10%) over the entire panel 102. That is to say that the exterior surface 112 generally conforms to the overall shape of the panel 102 without any protuberances 104 incorporated therein.

Looking to FIGS. 2A and 2B, the illustrated the panel 102 forms a substantially tubular or cylindrical shape when in the closed configuration that is coaxial with the body axis 140. As a result of the panel shape, the tissue contact surface 108 at least partially encloses about and defines the working volume 136 that also forms a substantially tubular or cylindrical shape (see FIG. 2A). The illustrated body reference surface 116 is also substantially tubular or cylindrical in shape passing through and corresponding to the overall shape of the panel 102 while being co-axial with the body axis 140. Still further, the illustrated exterior surface 112 is also substantially tubular or cylindrical in shape being co-axial with the body axis 140 when the panel 102 is in the closed configuration.

Looking to FIG. 3, the illustrated panel 102 is substantially planar when in the open configuration with the tissue contacting surface 108 in an open or unenclosed shape. Furthermore, the illustrated body reference surface 116 is also planar passing through and corresponding to the overall shape of the panel 102. The exterior surface 112 is also substantially planar when the panel 102 is in the open configuration.

As shown in FIG. 1, the panel 102 of the garment 100 includes a first or tissue-facing layer of sheet material 120 forming the tissue contacting surface 108, and a second or exterior layer of sheet material 124 coupled to the first layer 120 opposite the tissue contacting surface 108 to form an exterior surface 112 of the panel 102. During manufacturing, the second layer 124 is joined or otherwise coupled to the first layer 120 using adhesives, sewing techniques, lamination techniques, welding techniques, and the like. In some embodiments, the body reference surface 116 is defined by the interface between the first and second layers 120, 124 (discussed below). In other embodiments, the panel reference surface 116 is defined by the back or intermediate surface 142 of the first layer 120 (discussed below). In still other embodiments, the panel reference surface 116 is defined by the internal surface 184 of the second layer 124 (discussed below).

In the illustrated embodiment, the second layer of sheet material 124 is joined to the first layer of sheet material 120 such that at least a portion of the two layers 120, 124 may move independent of each other during use. In some embodiments, the two layers 120, 124 are joined (i.e., sewn, adhered, or welded) in a particular pattern to produce the desired relative movement between the two layers 120, 124. For example, in the illustrated example the first layer 120 is joined to the second layer 124 by stitching the two layers together only along the perimeters thereof (see FIG. 2B), leaving the material of both layers unconnected away from the perimeter. By doing so, the perimeters of the two layers of sheet material 120, 124 remain fixed in placed relative to each other (e.g., maintaining the overall positional relationship between the two layers 120, 124) while the remainder of the material of both layers 120, 124 (e.g., the material located away from the perimeter) is free to move and shift with respect to each other as the layers stretch, shrink, and change in shape relative to each other. Allowing for relative movement between the layers 120, 124 results in improved patient comfort and usability. The relative movement also allows for easier donning and doffing of the garment 100 and increased tissue stimulation for the patient.

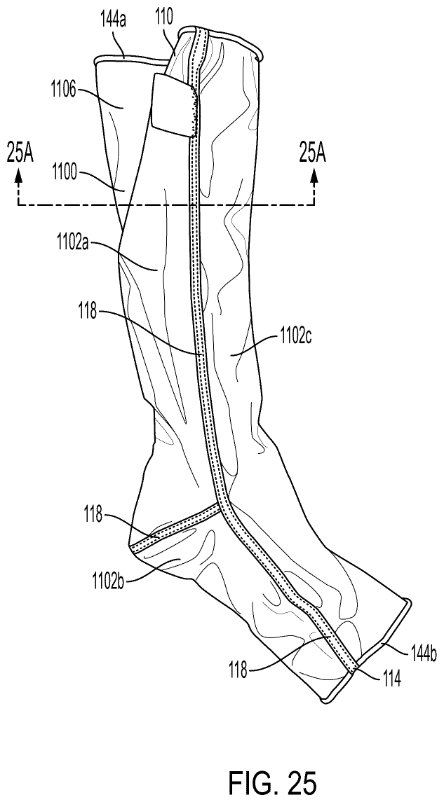

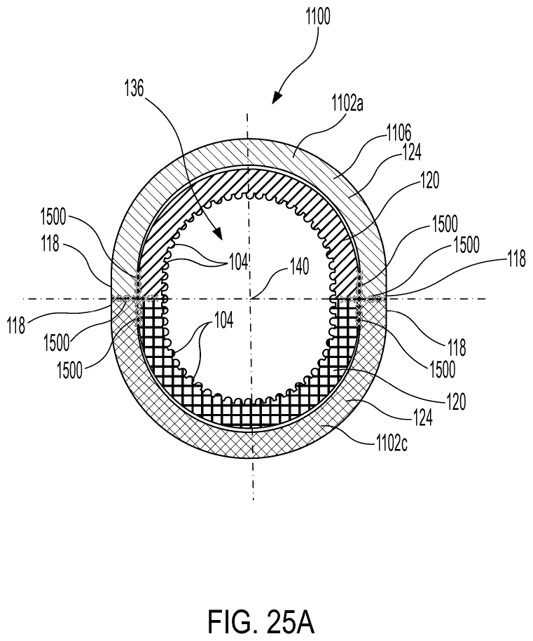

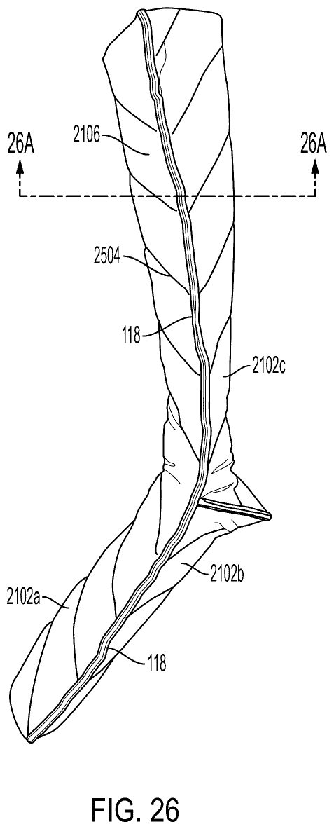

In embodiments where multiple panels 102 are present (see FIG. 25), the above-described relative movement between the two layers 120, 124 is present in each individual panel 102 making up the garment 1100. As such, the seams formed at the perimeters 118 of each individual panel 102 serves to both connect adjacent panels 102 and provide a connection location between the various layers forming the panels 102 themselves.

In other embodiments, the first layer 120 may be joined to the second layer 124 using a uniform adhesion method (i.e., lamination). In such embodiments, the two layers 120, 124 may be joined such that the two layers move and flex as a single piece of material. Joining the two layers 120, 124 together using uniform adhesion methods help to achieve lower elasticity in the final combined product.

With reference to FIGS. 2A, 3-5, the first layer 120 of the panel 102 is formed from a piece of pliable sheet material or fabric forming the first or tissue contacting surface 108 and a second or back surface 142 opposite the tissue contacting surface 108. The first layer 120, in turn, is formed or otherwise shaped so that the three-dimensional contour of the tissue contacting surface 108 includes one or more protuberances 104 included therein. In some embodiments, the protuberances 104 are formed into the first layer 120 such that they are present on the contacting surface 108 but not presence on the back surface 142. In other embodiments, the protuberances 104 are formed into the first layer 120 such that they are primarily extend from the contacting surface 108 (e.g., the protuberances 104 extend a further distance from the contacting surface 108 than they extend from the back surface 142).

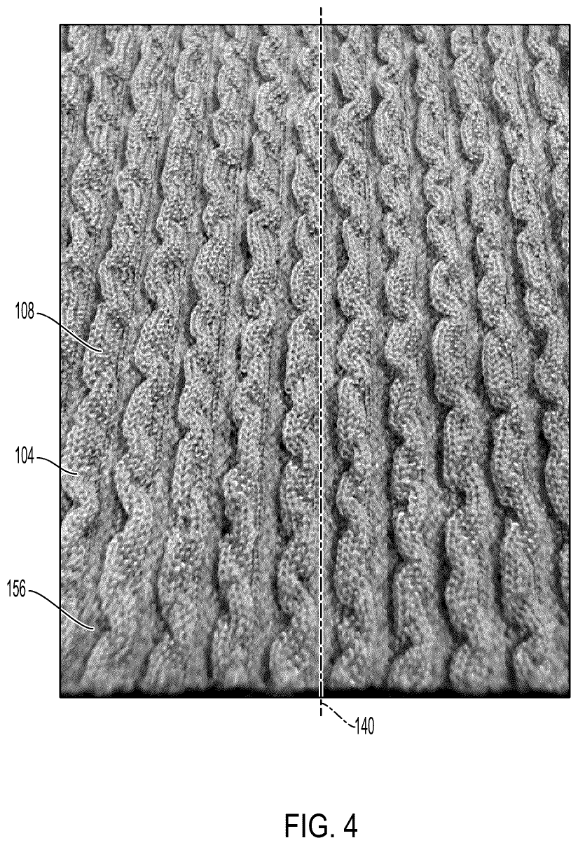

The sheet material forming the first layer 120 has a first thickness 148 (i.e. the distance between the contacting surface 108 and the back surface 142) that varies at different positions within the panel 102. The first thickness 148 of the sheet material varies to produce the one or more protuberances 104 without the need of any filler material between the inner and outer layers 120, 124 of the panel 102. In one construction, the material is manufactured such that relatively thick regions of the material 148a form a peak or protruding feature 152 and the relatively thin regions of the material 148b form a valley or recessed feature 156 (see FIGS. 4 and 5).

Furthermore, in some embodiments the material is manufactured such that varying the first thickness 148 impacts the curvilinear contour of the tissue contacting surface 108 greater than the curvilinear contour of the back surface 142. In still other embodiments, the back surface 142 remains a constant distance from the reference surface 116 independent of the first thickness 148 at that location while changes in the first thickness 148 cause the contacting surface 108 to vary in distance from the reference surface 116.

In some embodiments, the material of the first layer 120 is woven or knit in such a manner to generate the desired protuberances 104 in the tissue contacting surface 108 (see FIG. 4). In some embodiments, the first layer 120 is a fabric formed from a plurality of strands (e.g., yarns or threads), those strands are then incorporated into the protuberances 104 themselves. In still other embodiments, the material of the first layer 120 is configured such that protuberances 104 are formed without the aid of any supplemental materials or inserts being incorporated into the material itself. In still other embodiments, only strands forming the material of the first layer form the protuberances 104. However, in other embodiments, removing or adding material to the first layer 120 may be used to generate the desired protuberances 104.

In the illustrated embodiment, the first layer 120 of the garment 100 is formed from a breathable and stretchable material to ensure comfort and flexibility for the patient. In some embodiments, the material forming the first layer 120 has a first modulus of elasticity. In other embodiments, the attributes of the material forming the first layer 120 may be selected to influence the attributes of the protuberances 104 formed by the first layer 120. For example, the stiffness, and texture of the material forming the first layer 120 may be selected to produce a desired series of attributes for the protuberances 104 themselves. For example, the stiffness of the material forming the first layer 120 may be selected so that the resulting protuberances 104 have a desired firmness or resiliency when interacting with the patient's body. Namely, a stiffer material may be used in instances where a firmer protuberance 104 is desired or where it is desirable to have the protuberances 104 exert a greater force against the patient's skin without collapsing. In contrast, a softer material may be used in instances where a softer and/or more compliant protuberance 104 is warranted. In still other embodiments, the makeup of the material forming the first layer 120 may be treated or otherwise manufactured so that different regions of the first layer 120 have different attributes. By doing so, the resulting material can produce protuberances 104 in different areas having different attributes. For example, a first set of protuberances 104 may have a first firmness where the material is stiff while a second set of protuberances 104 may have a second firmness lower than the first firmness where the material is relatively less firm.

As shown in FIGS. 1, 4, and 5, the three-dimensional contour of the tissue contact surface 108 produces a series relatively high points or protuberances 104 that are each configured to interact with the patient's tissue during use and generate stimulation therewith. In the present embodiment, the size, shape, and location of the protuberances 104 are generally selected to target specific areas of the body where lymphatic drainage and fluid movement are desired.

Referencing FIG. 5, the illustrated tissue contact surface 108 defines a base level 160 and each protuberance 104 extends outwardly beyond the base level 160 (i.e., outwardly away from the back surface 142) to define a corresponding distal end 164. When shown in cross-section taken perpendicular to the direction of extension, each protuberance 104 defines a corresponding protuberance height 168, a protuberance cross-sectional shape 172, and a protuberance width 176.

In the illustrated embodiment, each protuberance 104 of the garment 100 includes an elongated ridge defining a ridge axis 150 extending parallel along the axial length 130 of the panel 102 (i.e., parallel to the axis 140 when the panel 102 is in the closed configuration) and spaced equally about the width 134 of the panel 102 (i.e., spaced equally circumferentially about the panel 102 when the panel 102 is in the closed configuration) to form a series of equally sized recessed features 156 therebetween. In some embodiments, the elongated ridges 104 may extend between the high-pressure region 110 and the low-pressure region 114. In still other embodiments, each ridge 104 may extend continuously from the high-pressure region 110 to the low-pressure region 114. In still other embodiments, the recessed features 156 may extend between the high-pressure region 110 and the low-pressure region 114. In still other embodiments, each recessed features 156 may extend continuously between the high-pressure region 110 and the low-pressure region 114.

In the illustrated embodiment, each protuberance 104 of the illustrated garment 100 has the same protuberance height 168, the same protuberance cross-sectional shape 172, and the same protuberance width 176. As shown in FIG. 5, each protuberance cross-sectional shape 172 (when viewed normal to the axis 140 when the panel 102 is in the closed configuration) includes a substantially rectangular shape with rounded or radiused corners. The illustrated protuberances 104 also maintain the same protuberance height 168 and width 176 along the entire length 130 of the panel 102.

In some embodiments, the elongated ridges 104 may form a wavy or “S” pattern as they extend along the ridge axis 150 (e.g., axially along the length of the panel 102; see FIG. 4). The illustrated ridges 104 have a protuberance width 176 of approximately 0.06 inches (±0.1%, ±0.5%, ±1%, ±2%, ±5%, or ±10%) and a protuberance height 168 of approximately 0.05 inches (±0.1%, ±0.5%, ±1%, ±2%, ±5%, or ±10%). In still other embodiments, the ridges 104 have protuberance height 168 that is substantially equal to the protuberance width 176 (±0.1%, ±0.5%, ±1%, ±2%, ±5%, or ±10%). In still other embodiments, the width of the recessed features 156 is approximately 0.05 inches (±0.1%, ±0.5%, ±1%, ±2%, ±5%, or ±10%). In still other embodiments, the width of the recessed features 156 are approximately the same as the protuberance width 176 (±0.1%, ±0.5%, ±1%, ±2%, ±5%, or ±10%).

While the illustrated protuberances 104 includes a series of elongated ridges extending parallel along the length 130 of the panel 102 (see FIG. 9), it is understood that in other embodiments different sizes, shapes, and layouts of protuberances 104 may be used. In some embodiments, the ridges may not run parallel along the length 130 of the panel 102 but rather extend at an angle relative thereto (see FIG. 10). In still other embodiments, a combination of parallel and non-parallel ridges 104 may be present (see FIG. 11).

In still other embodiments, the protuberance height 168 may vary relative to other protuberances 104 (see FIG. 6). In such embodiments, the variance within the different protuberance heights 168 may depend on different patterns, algorithms, treatment types, materials used, location of the body being treated, and the like. For example, the heights 168 may vary randomly, be based on the geometric position of the protuberance within the panel 102 (i.e., based on the distance from the perimeter 118), based on the proximity of the protuberance 104 to a target treatment point 180 within the panel 102 (see FIG. 17), or may vary as the result of a pattern within the layout of the protuberances 104 themselves (i.e., alternating higher and lower or wider and thinner, alternatingly growing and shrinking, and the like).

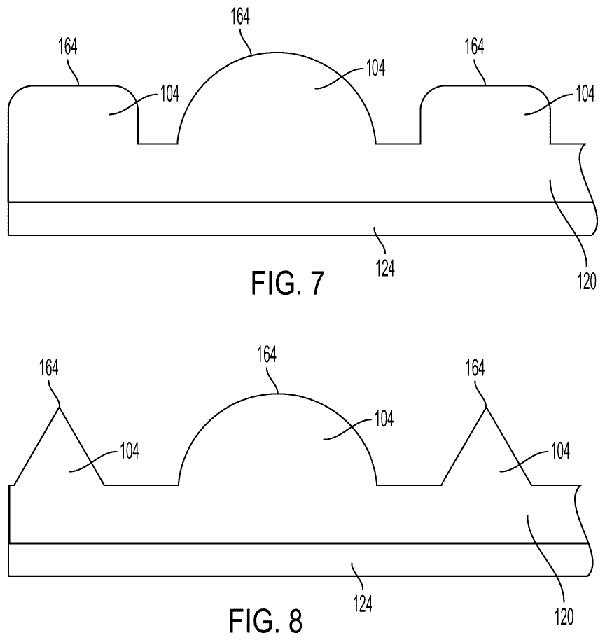

In still other embodiments, the cross-sectional shape 172 of the protuberances 104 may also vary. As stated above, the manner in which the cross-sectional shape 172 of the protuberances 104 may vary can dependent upon different patterns, algorithms, treatment types, materials used, location of the body being treated, and the like (see FIGS. 7 and 8). For example, the cross-sectional shape 172 may vary randomly, be based on the geometric position of the protuberance within the panel 102 (i.e., based on the distance from the perimeter 118), based on the proximity of the protuberance 104 to a desired treatment point 180 within the panel 102 (see FIG. 17), or may vary as the result of a pattern within the layout of the protuberances 104 themselves. A non-exhaustive list of potential cross-sectional shapes 172 that may be used to form the protuberance 104 is show in FIGS. 5-8.

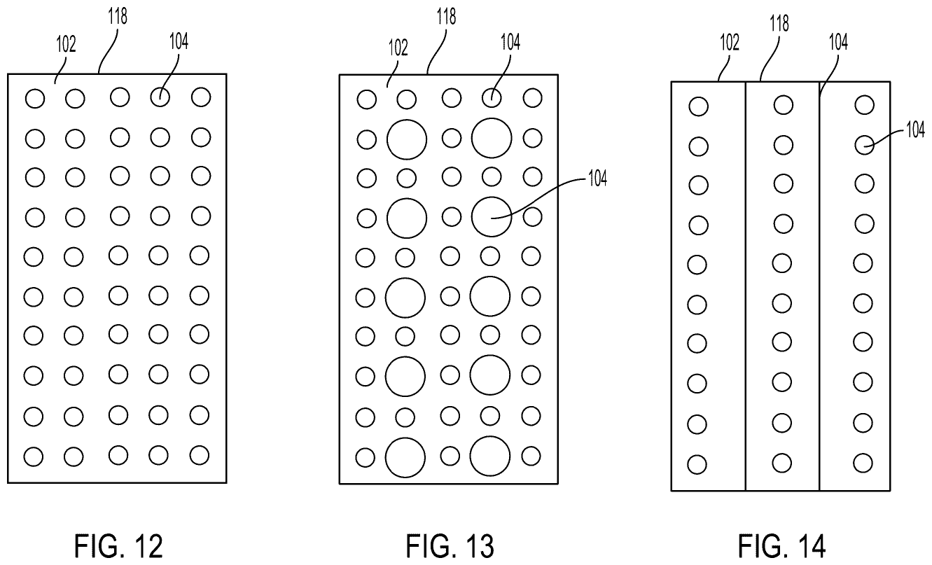

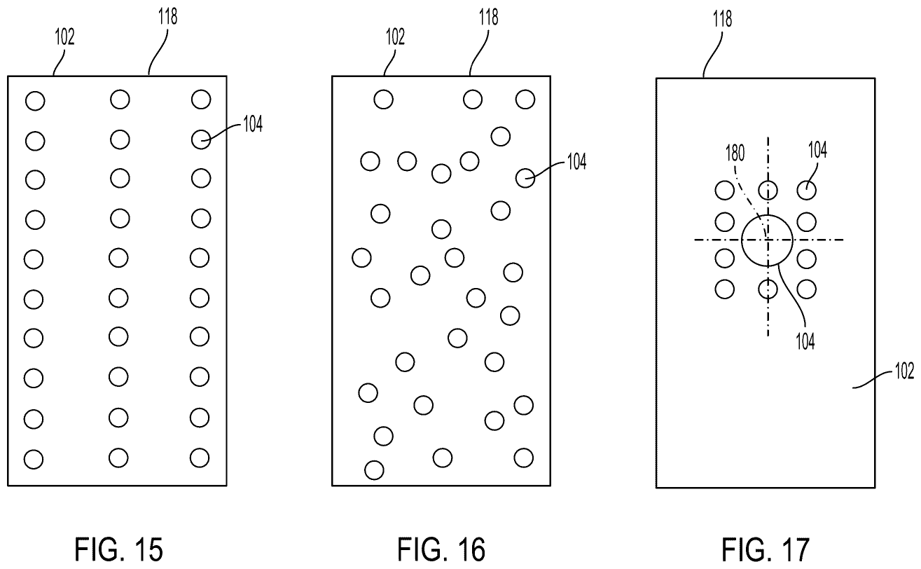

In still other embodiments, the types of protuberances 104 being used may vary. For example, while the illustrated embodiment includes a plurality of ridges (see FIGS. 9-11), it is understood that in other embodiments, mound-like or point protrusions 104 may also be used (see FIGS. 12-13, and 15-17). In such embodiments, the protuberance height 168 and cross-sectional shape 172 of the mound-like protrusions 104 may also vary as discussed above. In still other embodiments, a combination of ridge and mound-like protuberances 104 may be present (see FIG. 14).

Furthermore, the position of the protuberances 104 on the panel 102 may be influenced by various inputs such as adhering to patterns, use of algorithms, treatment types, materials used, location on the body being treated, and the like. For example, in some embodiments the protuberances 104 may be placed in a rectangular array over the entire panel 102 (see FIG. 12). In other embodiments, the distance between the protuberances 104 may mathematically calculated (i.e., as a percentage of the overall length 130 and/or width 134 of the panel 102, as a percentage of the height 168 of the given protuberance 104 or adjacent protuberances 104, and the like). In still other embodiments, the position of individual protuberances 104 on the panel 102 may be selected for anticipated alignment with particular aspects of the human body (i.e., a pressure point, a joint, a blood vessel, a nerve, and the like). In still other embodiments, the location of the protuberances 104 on the panel 102 may be randomly positioned (see FIG. 16).

In still other embodiments, the protuberances 104 may be positioned on the panel 102 in relation to a pre-determined target treatment point 180. As shown in FIG. 17, the target treatment point 180 is located on the panel 102 but the target's location may be influenced by an anticipated alignment with the patient's body once the garment 100 is being worn (i.e., alignment with a pressure point, a joint, a blood vessel, a nerve, and the like). In such embodiments, the position, size, or cross-sectional shape of the protuberances 104 on the panel 102 may be influenced by the protuberance's proximity to the target treatment point 180. In other embodiments, the panel 102 may only include protuberances 104 in the region immediately adjacent the target treatment point 180 for focused treatment. As such, one or more areas of the panel 102 may not include any protuberances 104 at all.

As shown in FIGS. 2A-3, and 5, the second layer 124 of the garment 100 is formed from one or more pieces of a pliable sheet material or fabric forming the external surface 112 and an internal surface 184 opposite the external surface 112. In the illustrated embodiment, the second layer 124 defines a second thickness 188 that is substantially uniform at all locations within the panel 102. As such, the exterior surface 112 generally corresponds with the overall shape of the panel 102 itself and is independent of the presence of any protuberances 104 in the inner layer 120. During use, the second layer 124 may include additional elastic properties relative to the first layer 120 to provide additional compression capabilities for the garment 100. More specifically, in some embodiments the material forming the second layer 124 has a second modulus of elasticity that is greater than the first modulus of elasticity of the first layer 120. In the illustrated embodiment, the second layer 124 is formed from a breathable and stretchable material to ensure comfort and flexibility for the patient.

In some embodiments, the second layer 124 is positioned outside the first layer 120 and is configured to compress the first layer into engagement with the at least a portion of the patient's body positioned within the treatment volume. In other embodiments, the second layer 124 supplements the compression forces generated by the first layer 120 when compressing the first layer into engagement with the patient's body. In still other embodiments, the second layer 124 as a whole (e.g., considering all panels 102 when multiple are present in the body) will at least partially encompass the first layer 120. In still other embodiments, the first layer 120 is positioned between the treatment volume 136 and the second layer 124. In still other embodiments, the second layer 124 completely encompasses the first layer 120 about the body axis 140.

While the illustrated garment 100 includes two layers 120, 124, it is understood that in other embodiments one or more intermediate layers may be present between the first layer 120 and the exterior layer 124. In such embodiments, all or a portion of the protuberances 104 may be formed by the intermediate layers such that they “push through” the inner layer 120 for engagement with the patient. For example, the intermediate layer may include a plurality of chopped foam pieces positioned between the first layer 120 and the second layer 124. In such embodiments, the size and shape of the chopped foam may be such that the edges of the foam pieces will “push through” the first layer 120 and engage the patient's skin.

In other embodiments, the intermediate layer may include loose fill or other cushioning in select locations. Such cushioning may only be provided in targeted areas or extend through the entire garment 100. Loose fill can be used to provide padding for patient comfort or to enhance the dimensional properties of the garment 100 itself. In some embodiment, loose fill may include cotton fill, loose padding, and the like.

In still other embodiments, the panel 102 may be formed from a single layer of material including both the tissue contact surface 108 and the exterior surface 112.

To manufacture a garment 100, the patient first obtains a piece of sheet material for forming the first layer 120 of the panel 102. In some embodiments, the sheet material is manufactured with the protuberances 104 already formed therein. For example, the illustrated first material is manufactured with a plurality of parallel ridges 104 formed (e.g., woven or knit) into the material.

With the first sheet material obtained, a first piece is then cut to the size and shape needed to produce the desired panel 102 shape. When cutting, the position and orientation of any protuberances 104 already formed into the material are taken into account. In the illustrated embodiment, a substantially rectangular piece of material is cut making sure the ridges 104 formed therein aligned parallel with the length 130 of the resulting panel 102. In embodiments where multiple panels 102 are required to form a given garment 100, this step may be repeated as necessary until the first layers 120 for all the needed panels 102 are prepared.

With the first material cut, the patient may then obtain a second piece of sheet material for forming the second layer 124. Once obtained, the sheet material is then cut to the size and shape needed to produce the desire panel 102 shape. In the illustrated embodiment, a substantially rectangular piece of material having the same geometry as the first piece of material is cut. In embodiments where multiple panels 102 are required to form a given garment 100, this step may be repeated as necessary until the second layers 124 for all the needed panels 102 are prepared.

With both pieces of material obtained, the first layer 120 may then be coupled to the second layer 124 to produce a finished panel 102. In the illustrated embodiment, the first layer 120 is coupled to the second layer 124 by sewing the two pieces of material together along the corresponding perimeters 118 thereof, leaving the interior of both layers 120, 124 free to move with respect to one another. In other embodiments, additional interior stitches may also be made. In still other embodiments where stiffer properties are warranted, the first layer 120 may be coupled to the second layer 124 using uniform adhesion methods (e.g., lamination or welding). In embodiments where more than one panel 102 is required to form a given garment 100, this step may be repeated as necessary until all the necessary panels 102 are formed.

With the panel 102 created, the panel 102 may then be enclosed to produce the final body 106 shape. To do so, the first seam edge 122 may be sewn or otherwise joined to the second seam edge 126. In the illustrated embodiment, sewing the first seam edge 122 to the second seam edge 126 forms the finished tubular or cylindrical shape. In embodiments where multiple panels 102 are present, the seam edges or perimeters 118 of adjacent panels may be sewn or otherwise jointed together to form the finished body 106 shape (see FIGS. 25-27). In some embodiments, such seams are located along the perimeters of each of the panels 102, however in other embodiments the connections may be made elsewhere as desired.

With the assembly of the garment 100 complete, the user may then insert the relevant portion of his or her body (i.e., an arm) into the garment 100 (e.g., into the treatment volume 136 thereof) such that any expansion of the garment 100 will result in a compressive force being applied to the body forcing the protuberances 104 into engagement with the patient's skin. In the illustrated embodiment, the stretching of the garment 100 that occurs as the patient dons the garment 100 results in compressive forces being generated by both the first layer 120 and the second layer 124 of each panel 102 included therein. Due to the location of the second layer 124 relative to the first layer 120, the compressive forces generated by the second layer 124 biases the first layer into engagement with the patient's body. In some embodiments, the compressive force of the second layer 124 may be greater than the compressive force generated by first layer 120 in a given location. In other embodiments, both layers 120, 124 may generate the same compressive force at a given location.

FIGS. 25 and 25A illustrate another embodiment of the garment 1100. The garment 1100 is substantially similar to the garment 100 described above so only the differences will be described in detail herein. The garment 1100 includes a body 1106 that is formed from a plurality of panels 1102a, 1102b, 1102c. Specifically, the body 1106 is formed from three panels 1102a, 1102b, 1102c. Each panel 1102a, 1102b, 1102c, in turn, is formed from two layers of material 120, 124 that are coupled to each other along the perimeters 118 thereof such that at least a portion of the first and second layers 120, 124 may move with respect to one another. In the illustrated embodiment, the two layers 120, 124 and adjacent panels 1102a, 1102b, 1102c are attached via stitches 1500 located along the perimeter 118 of each panel 1102a, 1102b, 1102c.

As shown in FIG. 25, the three panels 1102a, 1102b, 1102c are joined together to form the finished body 1106 shape. Specifically, the body 1106 is shaped like an open-toed sock that is sized to allow a patient to place his or her foot therein. In the illustrated embodiment, each panel 1102a, 1102b, 1102c is attached to the adjacent panels 1102a, 1102b, 1102c by sewing along the perimeters thereof. No stitches are present in the interiors of any of the panels 1102a, 1102b, 1102c. Once assembled, the finished body 1106 shape generates a compression gradient along the axial length there of (e.g., along the body axis 140) such that the compression forces generated proximate the second end 144b are greater than the compression forces generated at the first end 144a. As such, the compression forces generated away from the patient's core (e.g., proximate the patient's toes) is greater than the compression forces generated relatively closer to the patient's core (e.g., proximate the patient's calf).

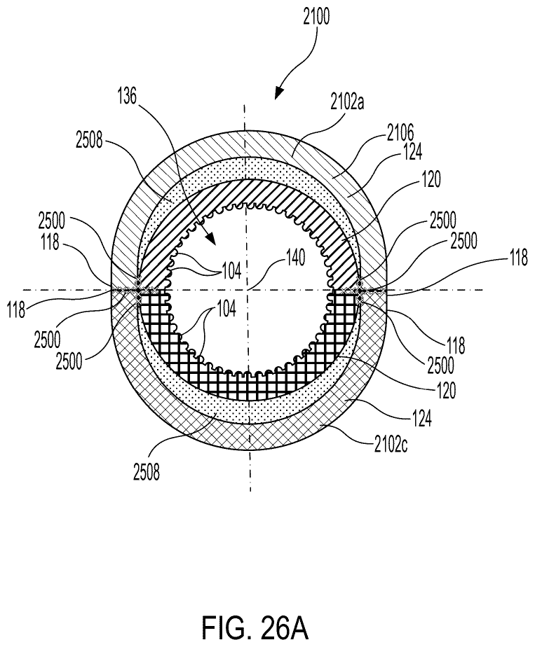

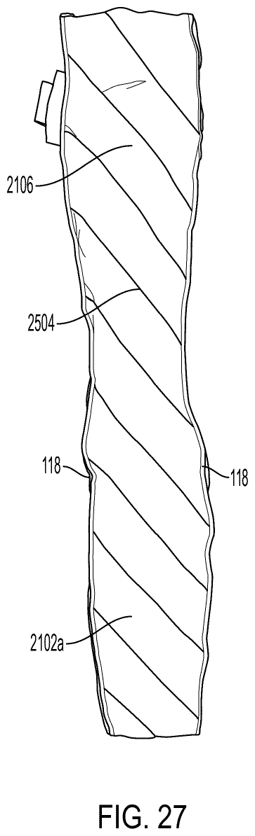

FIGS. 26-27 illustrate another embodiment of the garment 2100. The garment 2100 is substantially similar to the garment 1100 described above so only the differences will be described in detail herein. Each panel 2102a, 2102b, 2102c of the body 2106 includes an inner layer 120, and outer layer 124, and an intermediate layer 2508. In the illustrated embodiment, the intermediate layer 2508 includes loose fill (e.g., cotton). During assembly, the first and second layers 120, 124 are coupled together along the perimeters 118 thereof to form a gap therebetween in which the loose fill is placed (see FIG. 26A). The panels 2102a, 2102b, 2102c also include at least one internal stitch 2504 positioned within the interior of a given panel 2102a, 2102b, 2102c. The internal stitch 2504 serves minimize the overall thickness of the panels 2102a, 2102b, 2102c and minimize any movement of the loose fill. In the illustrated embodiment, each internal stitch extends linearly across the interior of the given panel 2102a, 2102b, 2102c and intersects the perimeter 118 on both ends thereof (see FIG. 27; e.g., the internal stitch begins and ends on the perimeter 118 of the corresponding panel 2102a, 2102b, 2102c).

What is claimed is:

1. A garment to be worn by a patient, the garment comprising:
a first layer of sheet material forming a tissue contacting surface, wherein the tissue contacting surface at least partially defines a treatment volume sized and shaped to receive at least a portion of the patient's body therein, and wherein the first layer of sheet material includes one or more protuberances formed into the tissue contacting surface and configured to engage the at least a portion of the patient's body when the at least a portion of the patient's body is positioned within the treatment volume; and
a second layer of sheet material coupled to the first layer of sheet material, wherein the second layer of sheet material is configured to compress the first layer of sheet material into engagement with the at least a portion of the patient's body when the at least a portion of the patient's body is positioned within the treatment volume.

2. The garment of claim 1, wherein the first layer of sheet material is a first fabric formed from a plurality of strands, and wherein the plurality of strands form the one or more protuberances.

3. The garment of claim 2, wherein the first layer of sheet material includes an intermediate surface opposite the tissue contacting surface, and wherein the protuberances are formed into the tissue contacting surface and not the intermediate surface.

4. The garment of claim 1, wherein the first layer of sheet material defines a first thickness, and wherein the first thickness varies to produce the one or more protuberances.

5. The garment of claim 1, wherein the first layer of sheet material is movable relative to the second layer of sheet material.

6. The garment of claim 1, wherein the first layer of sheet material is formed from one or more panels coupled together.

7. The garment of claim 6, wherein each panel includes a perimeter, and wherein the first layer is attached to the second layer along the perimeter of at least some of the panels.

8. The garment of claim 6, wherein each panel includes a perimeter, and wherein the first layer of sheet material is attached to the second layer of sheet material only at the perimeter of at least some of the panels.

9. The garment of claim 1, wherein the one or more protuberances include one or more elongated ridges.

10. The garment of claim 1, wherein the first layer of sheet material and the second layer of sheet material form a body, and wherein the body has a first end and a second end opposite the first end, and wherein the treatment volume is open on both the first end and the second end of the body.

11. The garment of claim 10, wherein the body is configured to apply a first compressive force at the first end, and a second compressive force less than the first compressive force at the second end.

12. The garment of claim 10, wherein the treatment volume defines a body axis, and wherein the protuberances include ridges extending substantially parallel to the body axis.

13. The garment of claim 1, wherein the second layer of sheet material encompasses the first layer and forms an exterior surface of the body.

14. The garment of claim 1, further comprising a third layer of material positioned between the first layer of sheet material and the second layer of sheet material.

15. The garment of claim 1, wherein the first layer of sheet material is formed from a first fabric type, and wherein the second layer of sheet material is formed from a second fabric type different than the first fabric type.

16. A garment to be worn by a patient, the garment comprising:
a first layer of sheet material forming a tissue contacting surface, wherein the tissue contacting surface at least partially defines a treatment volume sized and shaped to receive at least a portion of the patient's body therein, wherein the first layer of sheet material is formed from one or more panels coupled together, and where each panel includes a perimeter; and
a second layer of sheet material coupled to the first layer of sheet material along the perimeter of at least some of the panels, wherein the second layer of sheet material is configured to compress the first layer of sheet material into engagement with the at least a portion of the patient's body when the at least a portion of the patient's body is positioned within the treatment volume.

17. The garment of claim 16, wherein at least a portion of the first layer of sheet material can move relative to the second layer of sheet material.

18. The garment of claim 16, wherein the first layer includes one or more protuberances formed into the tissue contacting surface and configured to engage the patient's body.

19. The garment of claim 16, wherein the second layer of sheet material is coupled to the first layer of sheet material only along the perimeter of at least some of the panels.

20. The garment of claim 16, wherein the first layer of sheet material is a first fabric, and wherein the second layer of sheet material is a second fabric different than the first fabric.
